(19) United States
(12) Patent Application Publication
(10) Pub. No.: US 2009/0323880 A1
(43) Pub. Date: Dec. 31, 2009

(54) SYNCHRONIZATION OF REAL TIME DATA WITHIN DETERMINISTIC CLOCK EDGE

(75) Inventor: Eric P. Filer, Renton, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 12/163,556

(22) Filed: Jun. 27, 2008

(51) Int. Cl. H04L 7/00

(52) U.S. Cl. 375/376

(57) ABSTRACT

Techniques are disclosed for reducing clock slip in a system where real time data is transmitted over a wireless network. A wireless frame synchronization signal can be received from a remote device. The synchronization signal can be used to reset the clock that drives the wireless transmission of data, the clock that drives the analog to digital converter and/or a clock that drives a digital to analog converter.

### BACKGROUND

In a wireless network two apparatuses, e.g. a remote device and a device can transmit signals to each other in wireless frames. In order for this system to work correctly the internal clocks of the devices need to be synchronized so that each device can determine when to transmit data and when to expect incoming data. Generally one device sends a synchronization signal at predetermined time periods that the other device can use to configure itself. If the frame synchronization signal is not sent, in some cases the clocks will un-synchronize and data can be lost. In this case error correction code can reconstruct the missing data or the data can be retransmitted when the two devices re-synchronize. In this example lost data is not generally a problem because it is more important that the data is received eventually and the data is correct than if the data is received fast.

This however is not the case when the data is real-time data such as voice and/or video that needs to be processed by the remote device quickly otherwise the reduced audio and/or video quality will be noticed by a user. In order to ensure that data transmitted by the device is received on time the wireless radio of the device can be configured to transmit whatever data is stored in its buffer when a clock determines that it is time to transmit a frame of data. This ensures that data will be received by the remote device on time, however the transmitted data could be incorrect, e.g., the data could include an incomplete sample set or a corrupted sample set, which would also cause noticeable errors that will be perceived by the user.

In systems that include expensive components the tolerance of the clocks guarantees that frames will be transmitted at the correct time and the chance that a frame will include an error may be very low, e.g., once every 10 days. This however is not a luxury that all systems have due to budgetary and size constraints. Thus, in many cases both the clocks of the device and the remote device can have a frequency error of up to 500 parts per million (ppm), that is, up to 500 clock cycles for every million examined may be lost or added in. To give this error context, if the remote device uses the clock to send audio samples at 32000 samples per second (31.25 microseconds per sample), and the frames are sent every 8 milliseconds (256 samples per frame), each frame could be short or long by 4 microseconds due to the clock error. In a worst case scenario an entire sample set of data could be lost or an erroneous sample set could be gained every 8 frames (64 milliseconds). Currently an implementer may attempt to correct errors using firmware error correction techniques or by zeroing out frames that include bad data. These techniques however create audible effects that can be perceived by a user. Thus, techniques for synchronizing a device and a remote device that do not rely on expensive or bulky additional components are desirable.

### SUMMARY

In an example embodiment of the present disclosure, a method includes, but is not limited to, deriving a clock signal, wherein the clock signal is configured to be reset in response to a wireless frame synchronization signal received from a remote device; transmitting the clock signal to a phase lock loop, wherein the phase lock loop is configured to derive a second clock signal from the clock signal for an analog to digital converter, wherein the second clock signal is set to an internal frequency used by the analog to digital converter to digitize analog signals, further wherein the second clock signal is configured to be reset in response to the wireless frame synchronization signal received from the remote device; and transmitting, by a radio, digitized signals to the remote device, wherein the radio is configured to transmit the digital signals in wireless frames and the wireless frame transmission frequency is configured to be reset by the wireless frame synchronization signal. In addition to the foregoing, other aspects are described in the claims, drawings, and text forming a part of the present disclosure.

In an example embodiment of the present disclosure, a system includes, but is not limited to, a radio configured to receive a frame synchronization signal from a remote device; a timer including an input pin, a reset pin, and an output pin, wherein the input pin is configured to receive a clock signal, the output pin is configured to transmit an output clock to an analog to digital converter, and the reset pin is configured to receive the frame synchronization signal from the radio, further wherein the timer is configured to reset the output clock signal in response to receiving the frame synchronization signal from the radio; and further wherein the analog to digital converter is configured to use the clock signal received from timer to drive an internal clock of the analog to digital converter, wherein the internal clock is used to digitize analog signals. In addition to the foregoing, other aspects are described in the claims, drawings, and text forming a part of the present disclosure.

In an example embodiment of the present disclosure, a method includes, but is not limited to, generating a clock signal for a phase lock loop coupled to an analog to digital converter, wherein the phase lock loop is configured to generate an internal clock signal for an analog to digital converter from the clock signal, further wherein the analog to digital converter is configured to sample an audio signal at the frequency of the internal clock signal thereby generating a digital signal representative of a portion of the analog signal; receiving a wireless frame synchronization signal from a remote device over a wireless network; and resetting the clock signal in response to receiving the frame synchronization signal. In addition to the foregoing, other aspects are described in the claims, drawings, and text forming a part of the present disclosure.

The foregoing is a summary and thus contains, by necessity, simplifications, generalizations and omissions of detail. Those skilled in the art will appreciate that the summary is illustrative only and is not intended to be in any way limiting.

### BRIEF DESCRIPTION OF THE DRAWINGS

FIG. 1 depicts an example operational environment for practicing aspects of the present disclosure.

FIG. 2 depicts an example device including aspects of the present disclosure.

FIG. 3 depicts an operational flowchart for practicing aspects of the present disclosure.

FIG. 4 depicts an alternative embodiment of the operational flowchart of FIG. 3.

FIG. 5 depicts an operational flowchart for practicing aspects of the present disclosure.

FIG. 6 depicts an alternative embodiment of the operational flowchart of FIG. 5.

### DETAILED DESCRIPTION

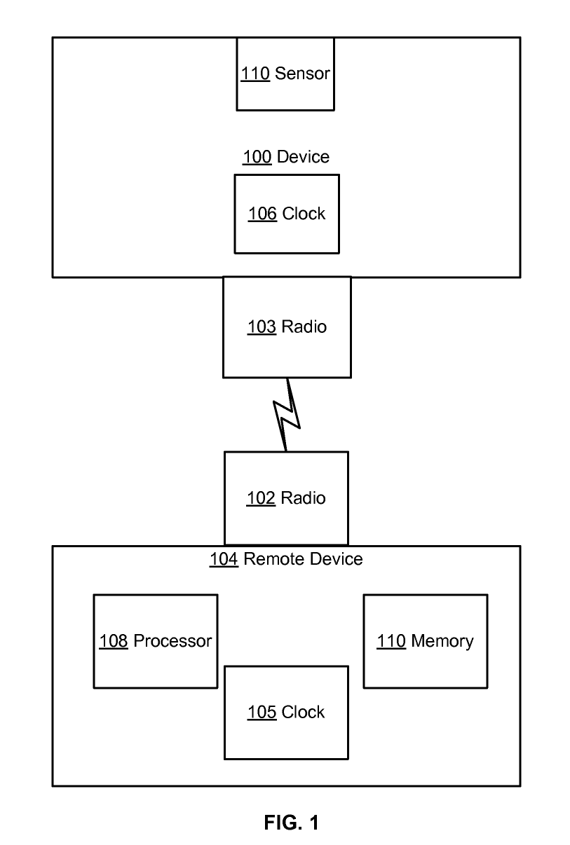

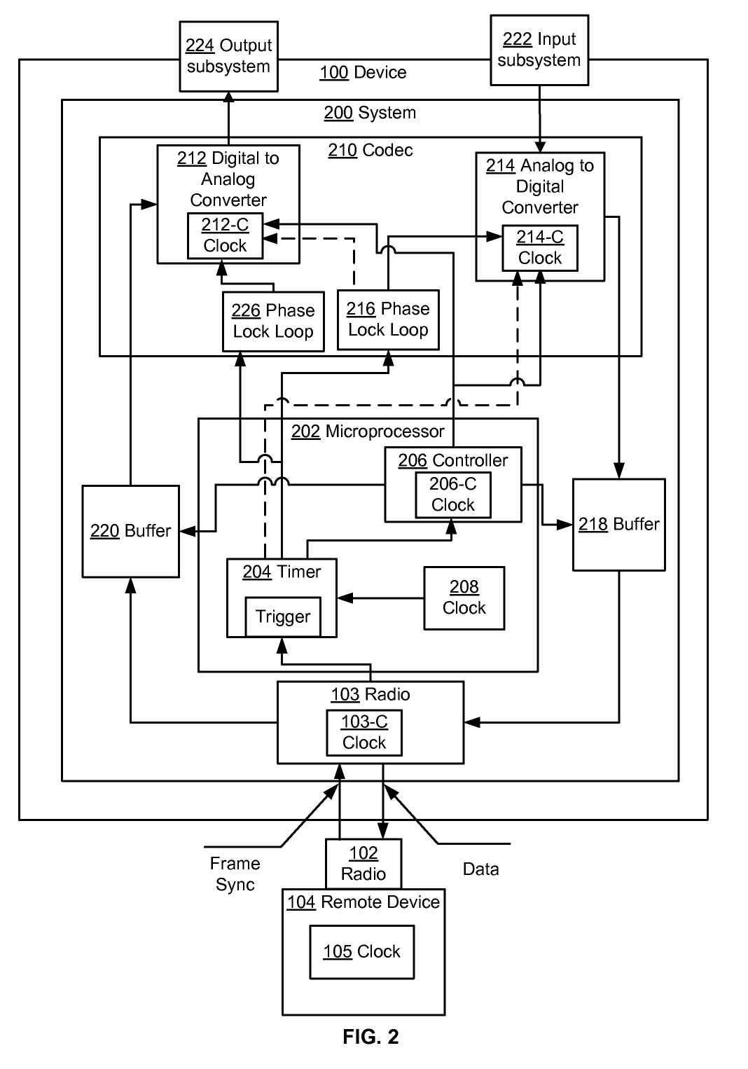

Referring now to FIG. 1 and FIG. 2, they depict example high level operational environments for practicing aspects of the present disclosure. One skilled in the art will note that the example elements depicted in FIG. 1 and FIG. 2 are illustrated to provide an operational context for practicing aspects of the present disclosure and in some embodiments the physical layout of operational environments may be different, thus the example operational contexts are to be treated as illustrative only and in no way limit the scope of the claims. One skilled in the art can also appreciate that the following discussion is interdictory and the elements depicted by FIG. 1 and FIG. 2 will be described in more detail in the following paragraphs.

As illustrated by FIG. 1, in certain embodiments a remote device 104 can be in wireless communication with a device 100. Generally speaking, a remote device 104 in certain embodiments can include, but is not limited to, a videogame console, a personal computer, a wireless router, a cellular phone, a video recorder, or any other device that is capable of sending and/or receiving wireless signals. Device 100 can in general include, but is not limited to, a wireless headset, a wireless ear piece, a wireless microphone, a cellular phone, a videogame controller, a video recorder, or any other device that is capable of sending and/or receiving wireless signals. Continuing with the general description of FIG. 1, the remote device 104 in this example additionally includes a processor 108 and a radio 102 that can be in wireless communication with a radio 103 of device 100. In this depicted embodiment the radio 102 and 103 can be coupled to a wireless adaptor, an Ethernet switch, and/or router firmware configured to provide Internet Protocol Routing. In a specific example embodiment the radio 102 and 103 can include a Bluetooth radio and/or a Wi-Fi radio. Generally speaking, radios 102 and 103 can send data to each other in one or more wireless frames. Generally, a wireless frame can include a control field and a body that carries information such as TCP/IP and UDP packets. A frame can in an embodiment be though of as a window for sending data, and each radio 102 and 103 can determine the size of the window and the frequency that the window occurs. As briefly mentioned above, each radio 102 and 103 can use a clock 105 and 106 respectively in order to control the timing for transmitting information in the wireless frames. In some example embodiments the clocks 105 and 106 can include crystal oscillators that are configured to generate repetitive electronic signals. The components of the clocks can include a piezoelectric crystals coupled to filters and amplifiers. An electronic signal can be fed through the filters until the desired sinusoidal frequency is obtained.

In embodiments of the present disclosure the frequency of the clocks can vary and create clock slip. This clock slip essentially means that clocks 106 and 105 will never exactly oscillate at the same frequency and thus clocks derived from these base clocks, e.g., the clocks that drive radios 103 and 102, will be slightly off. In order to synchronize wireless signals one radio, for example radio 102 of the remote device 104 can be configured to send a frame synchronization signal to radio 103 of device 100 periodically in order to synchronize the radios. The frequency at which this frame synchronization signal is sent depends on multiple factors such as how much clock slip can be tolerated. For example, in a system that uses expensive clocks a synchronization signal may not need to be sent for a long time, whereas in systems that use cheaper clocks such as those found in consumer electronics, e.g., routers and wireless headsets, the synchronization signal may need to be sent much more frequently. The subcomponent that derives the internal clock of radio 103 in this example embodiment can include an output pin and a reset pin that can be triggered by, controller firmware or built in timer hardware of the radio 103 when the frame synchronization signal is received over the wireless network, thus even if clock 105 and 106 drift from each other the internally derived clocks of the radios can be resynchronized by a frame synchronization signal.

The problem of clock slip with respect to the radios is compounded by the fact that clock slip can occur with respect to other circuits that use internal clocks derived from clock 106 such as a sensor 110. For example, if an analog to digital converter uses a clock signal derived from clock 106 the rate at which an analog signal is digitized can start to slip. In the situation where real time data is transmitted by the radio 103, if the analog to digital converter clock has slipped then the A to D converter may generate a digital representation of an analog signal at a rate that is either too slow or too fast for the radio 103. Thus, the radio 103 may start to send sample sets that are incomplete, e.g., in the instance that the clock is slow, or the radio 103 may start to drop samples, e.g., in the instance that the clock is fast.

Referring now to FIG. 2, it depicts an example operational environment for practicing aspects of the present disclosure. As illustrated by FIG. 2, in an example embodiment the clock slip of an A to D converter 214 and radio 103 in relation to radio 102 can be mitigated. Generally, system 200 can include a microprocessor 202 that can in some embodiments include an ARM based architecture, e.g., a 32-bit RISC processor. Generally, microprocessor 202 can include in at least one embodiment a clock 208 that can have similar components to clocks 105 and/or 106 of FIG. 1, a controller 206, and a timer 204, e.g., a timer counter. While microprocessor 202 is depicted as including a timer 204 and a clock 208, other embodiments exist, thus timer 204 and clock 208 can be separate components operatively connected to the microprocessor 202. In some example embodiments the timer 204 can include a hardware component that can be part of the microprocessor 202 and it can include at least one input, at least one output, and a trigger that can be configured to perform a variety of actions in response to a triggering event, e.g., it could start, stop, and/or reset signals. The controller 206 can in some embodiments include a hardware component such arithmetic and logic elements, RAM, ROM, EEPROM, and input/output interfaces. As illustrated by FIG. 2, in at least one example embodiment the clock signal output by the timer 204 can be used to drive an internal clock 206-C of the controller 206. In this example embodiment the clock signal of the controller 206 can be synchronized to the internal clock 214-C of the analog to digital converter 214 and the internal clock 103-C of radio 103. In addition to the microprocessor 202, system 200 in some embodiments can include a buffer 218 and/or buffer 220. For example, in certain embodiments the buffer can include memory such as a series of registers and/or RAM. In certain embodiments buffer 218 can be located on the microprocessor 202 in a microcontroller.

In addition to microprocessor 202, the depicted system 200 can include a codec 210 that can in some embodiments include an analog to digital converter 214, a phase lock loop 216, and a digital to analog converter 212. A codec 210 in example embodiments can include a hardware component that can be configured to digitize analog signals and in some instances convert digital signals back into analog signals for use by other devices. The analog to digital converter 214 is generally configured to sample an analog signal according to a sampling frequency that dictates when the converter obtains a value. Generally, more samples taken over a given time period will result in a better the digital representation of an analog signal. In one example embodiment the analog to digital converter 214 can include a signal input, an internal clock 214-C, one or more comparators, e.g., circuits that compare voltage or current to preset values and toggle internal switches to indicate when current or voltage is larger than the values, and registers to store the results from the comparators. When the analog signal is received the comparator(s) can obtain digital values during each internal clock cycle of clock 214-C and store the values in the registers. As illustrated by FIG. 2, in at least one embodiment the codec 210 can include a phase lock loop 216 that can be used to output a signal to internal clock 214-C of analog to digital converter 214. In an embodiment the phase lock loop 216 can be used as a control system that generates a signal fixed to the frequency of the signal transmitted by the timer 204. Generally in order to obtain a good representation of the analog signal the internal clock 214-C of the analog to digital (A to D) converter must generate a signal at a frequency equal to the sampling frequency multiplied by an integer such as 128 or 256. For example, at a sampling frequency of 32 KHz, e.g., for voice signals, the frequency of clock 214-C should be set to approximately 8 MHz. In certain embodiments of the present disclosure the phase lock loop 216 can be configured to generate a signal used by the internal clock 214-C for the A to D converter 214. In an example embodiment the phase lock loop 216 can include an electronic oscillator and a frequency divider that can be used to generate a frequency that is a multiple of the input signal in order to generate a frequency that can be used to drive the clock of the analog to digital converter, e.g., a clock of 8 MHz in the example from above.

The following are a series of flowcharts depicting implementations of processes. For ease of understanding, the flowcharts are organized such that the initial flowcharts present implementations via an overall “big picture” viewpoint. Those having skill in the art will appreciate that the style of presentation utilized herein (e.g., beginning with a presentation of a flowchart(s) presenting an overall view and thereafter providing additions to and/or further details in subsequent flowcharts) generally allows for a rapid and easy understanding of the various operational procedures.

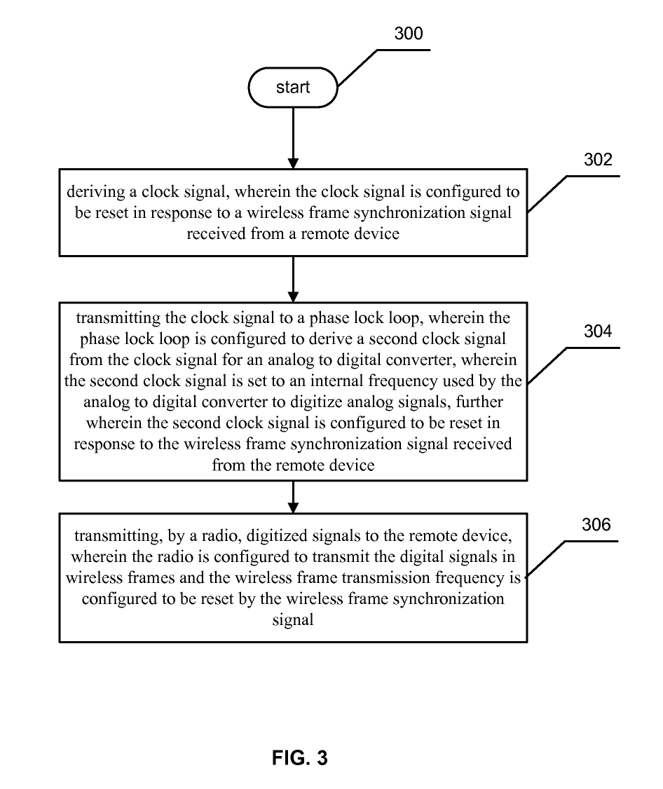

Referring now to FIG. 3, it depicts example operational procedures according to example embodiments of the present disclosure. As illustrated by FIG. 3, operation 300 begins the operational procedure and operation 302 illustrates deriving a clock signal, wherein the clock signal is configured to be reset in response to a wireless frame synchronization signal received from a remote device. For example, and referring to FIG. 2, in an example embodiment a device 100 such as, for example, a video recorder, a microphone, a headset (including a microphone and a speaker), a mobile device (also including a microphone and a speaker), and/or a controller, (including an accelerometer, and/or a microphone and/or a speaker), can be in wireless communication with a radio 102 of a remote device 104 such as, but not limited to, a videogame console, a mobile device, a wireless router, a personal computer. More specifically, in an example embodiment device 100 can be a wireless ear piece and the remote device 104 can be a mobile phone. The mobile phone in this example can be configured to connect to a mobile network in order to establish telephone calls with other users. In this example the mobile phone can transmit voice signals received from other phones to the wireless ear piece over a, for example, Bluetooth wireless connection and receive voice signals from a user of the ear piece. In another specific example, device 100 can be a wireless microphone and remote device 104 can be a videogame console. In this example the wireless microphone can transmit voice signals over a Wi-Fi network to a videogame console, e.g., in the example where a user is playing a karaoke videogame. In this example the videogame console can generate an analog signal from the signal received from the microphone and output the signal to a speaker. In yet another embodiment device 100 can be a videogame controller that can include an accelerometer. The videogame controller can be configured to digitize signals indicative of the movement of the controller and transmit them to the videogame console via an inferred signal. The videogame console can use the signals to interact with the game, e.g., the controller could be swung as a sword by a user and the videogame console could use information that identifies the speed at which the controller was swung to determine how much damage a sword would inflict.

Continuing with the description of operation 302, in an embodiment of the present disclosure device 100 can include a system 200 of FIG. 2. In this example embodiment the system 200 can include a clock 208 having a crystal oscillator that is generally described in the preceding paragraphs. As depicted by FIG. 2, the output of clock 208 can in at least one embodiment be fed into timer 204. In this example embodiment timer 204 can be configured to receive the clock signal from clock 208 and derive an output signal (the sample clock) that can be used to drive an internal clock 214-C of the A to D converter. In this example, radio 103 can be configured to generate a signal when it receives a wireless frame synchronization signal from radio 102 and the signal can be fed into a trigger of timer 204. The trigger can be configured in this example embodiment to reset the output of the timer 204 in response to receiving the wireless frame synchronization signal from radio 103. Thus, in this example the downstream clocks 214-C can be forced to stay synchronized with the wireless frame synchronization signal.

Continuing with the description of operation 304, it depicts transmitting the clock signal to a phase lock loop, wherein the phase lock loop is configured to derive a second clock signal from the clock signal for an analog to digital converter, wherein the second clock signal is set to an internal frequency used by the analog to digital converter to digitize analog signals, further wherein the second clock signal is configured to be reset in response to the wireless frame synchronization signal received from the remote device. For example, in an embodiment of the present disclosure the signal output by timer 204 can be fed into a phase lock loop 216 operable to generate the a signal that can drive clock 214-C of the A to D converter 214. For example, in certain embodiments of the present disclosure that include a phase lock loop 216, timer 204 may not be capable of deriving an internal signal that is capable of operating at a frequency needed to drive A to D conversion and phase lock loop 216 is needed. In this embodiment an implementer may not want to add additional components to system 200 to keep the size and/or cost of system 200 down. In this embodiment the implementer may want to utilize components already found in a codec 210 and a microprocessor 202. In this embodiment the phase lock loop 216 can be configured to generate a signal that is fixed to the frequency of the signal transmitted by the timer 204. In this embodiment, clock 214-C of A to D 214 is essentially locked to the rate at which frames are transmitted by the radio 103. In addition, in at least one example embodiment internal clock 206-C of controller 206 can be synchronized to the radio 103 and the phase lock loop 216. In this example embodiment the controller 206 can be configured to direct the A to D 214 to send data to buffer 218 when the output signal of the timer 204 changes state. By configuring the timing of the controller 206, clock 206-C can be configured to change state when the last sample for a frames worth of data is digitized and direct the A to D converter 214 to transmit samples to a buffer 218.

As is illustrated by the dashed lines of FIG. 2, in other example embodiments the timer 204 can be configured to include internal components operable to divide down a clock signal from clock 208 to an internal clock rate operable to drive clock 214-C of the A to D converter 214. In these embodiments the clock rate generated by the timer 204 can be synchronized to the frequency associated with the transmission of frames.

Continuing with the description of FIG. 3, operation 306 depicts transmitting, by a radio, digitized signals to the remote device, wherein the radio is configured to transmit the digital signals in wireless frames and the wireless frame transmission frequency is configured to be reset by the wireless frame synchronization signal. For example, and in addition to the preceding example, radio 103 can be configured to transmit a wireless frames worth of digitized real time data to radio 102 of remote device 104. For example, in an embodiment of the present disclosure analog to digital converter 214 can be configured to digitize a set of values that represent a portion of an analog sound such as voice. When a sample set is complete the controller 206 can be configured to direct the analog to digital converter 214 to transmit the sample set to buffer 218 where it can be stored in a queue. The radio 103 in this example can be configured to load sample sets into an internal buffer and transmit one or more sample sets to the remote device 104 during the next window.

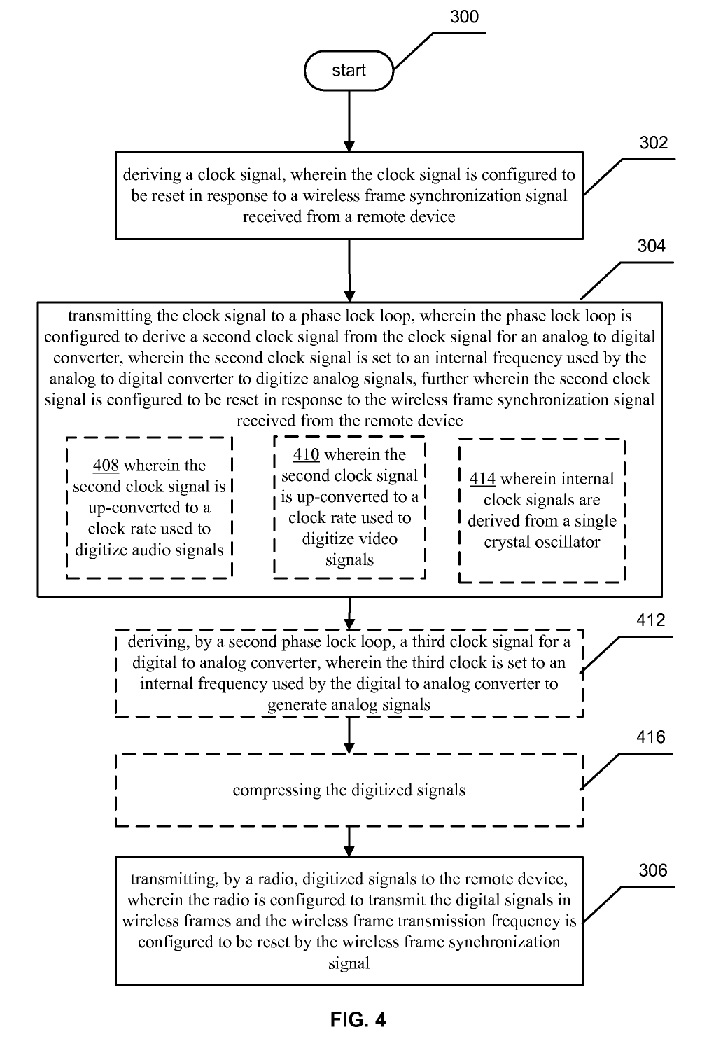

Referring now to FIG. 4, it depicts an alternative embodiment of the operational procedure 300 of FIG. 3 including the additional operations 408, 410, 412, 414, and 416. Referring now to operation 408, it illustrates transmitting the clock signal to a phase lock loop, wherein the phase lock loop is configured to derive a second clock signal from the clock signal, and wherein the second clock signal is up-converted to a clock rate used to digitize audio signals. For example, in an embodiment of the present disclosure the analog real time signal can include an audio signal such as voice. In this example system 200 can include an input subsystem 222 such as a microphone. For example, in this embodiment device 100 could include a hand held microphone, an ear piece with a microphone, or a headset with a microphone. In this embodiment the A to D converter 214 can be configured to process the analog voice signal received from input subsystem 222 and generate a digital representation of the analog signal. In certain embodiments of the present disclosure in order to accurately represent voice the internal clock of the A to D converter 214 should be driven at a frequency within a certain range otherwise the digital representation will not include enough information to reconstruct an analog signal. In this example embodiment the phase lock loop 216 can be configured to generate an internal clock that operates at a frequency suitable to digitize audio signals, e.g., a frequency of or around 8 MHz (sampling rate of 32 KHz multiplied by number of samples 256).

Referring now to operation 410, it illustrates transmitting the clock signal to a phase lock loop, wherein the phase lock loop is configured to derive a second clock signal from the clock signal, and wherein the second clock signal is up-converted to a clock rate used to digitize video signals. For example, in certain embodiments of the present disclosure the analog real time signal includes an analog signal such as video. In this example system 200 can include an input operation to capture an input subsystem 222 that can include a video source such as a VCR or handheld video recorder. In this embodiment the A to D converter 214 can be configured to process the analog video signal received from input subsystem 222 and generate a digital representation of the analog signal. In this example embodiment the phase lock loop 216 can be configured to generate an internal clock that operates at a frequency suitable to digitize video signals.

Referring now to operation 412, it illustrates deriving, by a second phase lock loop, a third clock signal for a digital to analog converter, wherein the third clock is set to an internal frequency used by the digital to analog converter to generate analog signals. For example, in an embodiment of the present disclosure system 200 can include an output subsystem 224 that is operable to provide a digital output. For example, in this embodiment device 100 could include a mobile phone, a wireless headset or an ear piece. In this example audio signals may be received from the remote device 104 that could be, for example, a wireless router, a personal computer, and/or a mobile phone. More specifically, remote device 104 could be a wireless router that receives voice over IP (VOIP) signals from a service provider and transmits the signals to a user's mobile phone while the user is located at home. In this example the user may not use their wireless minutes while they are receiving phone calls over VOIP. In this example the same problem exists if the D to A converter 212 does not convert digital signals into an analog signal fast enough because radio 103 is receiving voice at a set rate governed by the frame synchronization signal and the real time voice data needs to be processed within a certain time in order to provide a good user experience. In this example system 200 codec 210 can include an additional phase lock loop 226 that can be configured to up-convert the signal output by the timer 204 to a frequency suitable to drive clock 212-C of the D to A converter 212. The D to A 212 can then be configured to convert a digital signal received from remote device 104 into an analog signal that can be output by for example, a speaker.

Referring now to operation 414, it illustrates wherein internal clock signals are derived from a single crystal oscillator. For example, in certain embodiments of the present disclosure the system 200 may include a clock 208 that includes a single crystal oscillator and all other internal clocks, e.g., the clock of the codec 210, the phase lock loop 216, clocks 214-C, 206-C, 103-C, and 212-C are derived from clock 208. In this example embodiment the price of the production costs associated with system 200 are kept to within reasonable levels for mass production of consumer electronics. For example in some embodiments adding an additional crystal oscillator to a system essentially adds $0.10 dollars to the price of the system. If the system 200 is used in a device 100 that is massed produced, e.g., on the scale of millions, over the price of the product line the configuration of the system to derive all the internal clocks from a single crystal oscillator saves a significant amount of money.

Referring now to operation 416, it illustrates compressing the digitized signals. For example, in some embodiments of the present disclosure the microprocessor 202 is configured to compress the digital data set representative of a portion of the audio signal before the radio 103 transmits the signal to the radio 102 of remote device 104. For example in an embodiment multiple sample sets can be compressed and transmitted within a single wireless frame. For example, the microprocessor 202 can be configured to compress the digital samples using a compression algorithm in order to encode information using fewer bits. In addition, in certain embodiments the digitized signal can be compressed in order to add error correction bits that can be processed by error correction code running on the remote device 104. In this embodiment then multiple samples can be placed within a frame and transmitted to the radio 103 of the remote device 104.

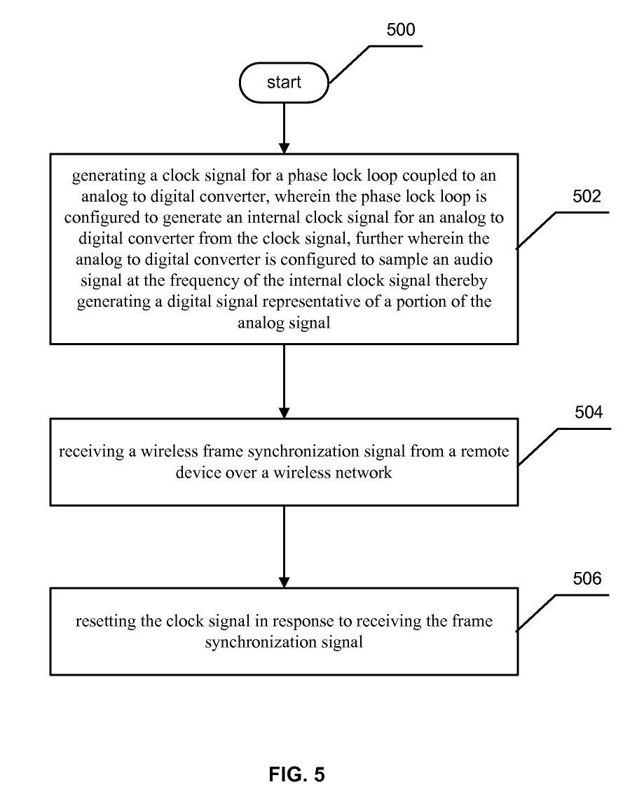

Referring now to FIG. 5, it illustrates example operational procedures according to example embodiments of the present disclosure. As illustrated by FIG. 5, operation 500 begins the operational procedure and operation 502 illustrates generating a clock signal for a phase lock loop coupled to an analog to digital converter, wherein the phase lock loop is configured to generate an internal clock signal for an analog to digital converter from the clock signal, further wherein the analog to digital converter is configured to sample an audio signal at the frequency of the internal clock signal thereby generating a digital signal representative of a portion of the analog signal. For example, and referring to FIG. 2, a sinusoidal clock signal can be generated by an oscillating crystal of clock 208. In this example clock 208 can be part of a microprocessor 202 and the clock signal from clock 208 can be fed into timer 204. In this example embodiment timer 204 can be configured to output the clock signal to a phase lock loop 216 operatively coupled to an analog to digital converter 214. The phase lock loop 216 can be configured to include a divider that can divide down the output signal from timer 204 to a frequency suitable to drive clock 214-C of analog to digital converter 214. In this example embodiment the phase lock loop 216 can be configured to generate a signal that is fixed to the frequency of the signal transmitted by the timer 204. For example, in this example embodiment the timer 204 may be a component of the microprocessor 202 and the timer 204 may not be capable of deriving an internal signal that is capable of operating at speeds needed for A to D conversion of real time audio signals, e.g., the timer 204 may not be able to divide down the signal. In this example embodiment the production cost and size of system 200 can be kept low by relying on components already found in a codec 210 and a microprocessor 202.

Continuing with the example, operation 504 illustrates receiving a wireless frame synchronization signal from a remote device over a wireless network. For example, timer 204 in this embodiment can be configured to receive a wireless frame synchronization signal from radio 103. In an example embodiment the frame synchronization signal can include, but it not limited to, a number of bits that represent a synchronization signal, e.g., a syncword. The bits in this example embodiment can be stored in memory of the radio 103 and a comparator can check the pattern of the received bits to a predetermined bit pattern. In the instance that a match is detected, the comparator can change state and synchronize the radio 103. In addition, the output of the comparator can be fed into a trigger pin of timer 204. In this example the trigger pin of the timer 204 can be configured to reset the output signal of timer 204 when the state changes.

Continuing with description of FIG. 5, operation 506 illustrates resetting the clock signal in response to receiving the frame synchronization signal. For example, trigger of timer 204 in this example embodiment can detect a change in state that indicates that a wireless frame synchronization signal was received. In response to the signal, the trigger can reset the frequency of the clock output by the timer 204. In this example embodiments the phase lock loop 216 can be configured to generate a signal that is fixed to the frequency of the signal output by the timer 204. In this example, the clock 214-C of A to D 214 can receive the signal output by the phase lock loop 216 and is therefore locked to the rate at which frames are transmitted by the radio 103.

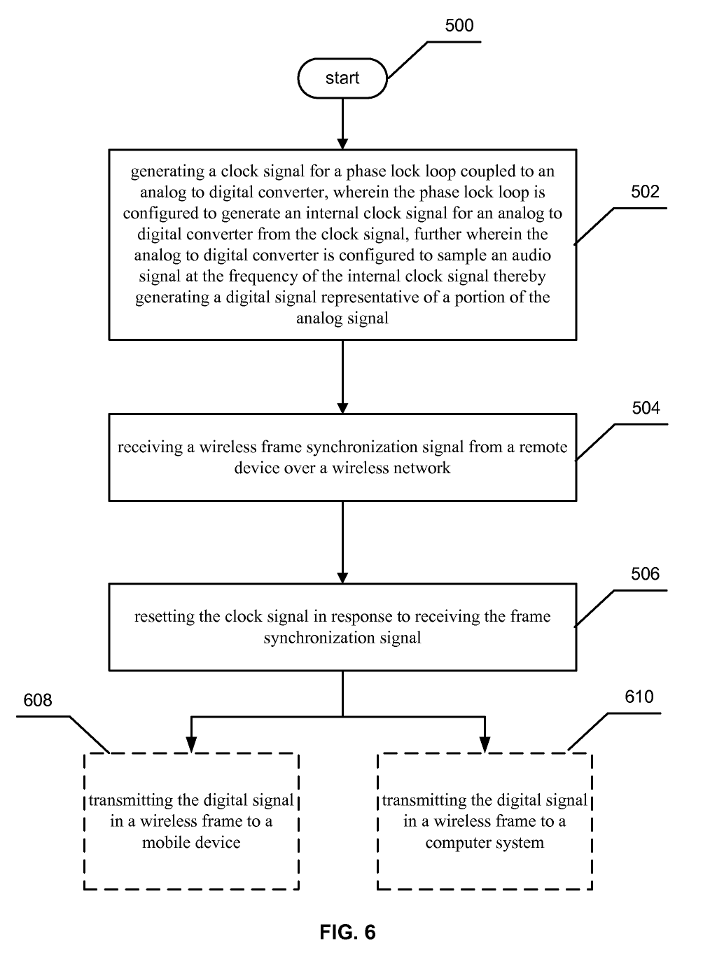

Referring now to FIG. 6, it depicts an alternative embodiment of the operational procedures of FIG. 5 including additional operations 608 and 610. Referring to operation 608, it illustrates transmitting the digital signal in a wireless frame to a mobile device. For example, and in addition to the preceding example radio 103 can be configured to transmit a wireless frames worth of digitized real time data to the radio 102 of remote device 104. In this example embodiment radio 103 can be configured to transmit the digital signal to a radio 102 of a mobile device such as a cellular phone. In this example embodiment system 200 can be included in, for example, a wireless headset. The operator of the headset may speak into a microphone and the voice can be digitized. The A to D converter can be configured to digitize the incoming analog signal and generate sample sets that represent portions of the voice. In this example embodiment the size of the sample set can be related to the bandwidth available in each frame. Thus, in this embodiment, the internal clock of the A to D converter 214-C can synchronized with the radio 102 and the sample sets can be generated by the A to D 214. The sample sets in this example can then be processed by the microprocessor 202 in time for the radio 103 to request a set; and transmit a set within the window of time specified by the wireless frame rate.

Referring to operation 608, it illustrates transmitting the digital signal in a wireless frame to a computer system. For example, and in addition to the preceding example radio 103 can be configured to transmit a wireless frames worth of digitized real time data to the radio 102 of remote device 104. In this example embodiment radio 103 can be configured to transmit the digital signal to a radio 102 of a personal computer that can be operating a voice over internet protocol program. In this example embodiment system 200 can be included in, for example, a wireless headset. The operator of the headset may speak into a microphone and the voice can be digitized. The A to D converter can be configured to digitize the incoming analog signal and generate sample sets that represent portions of the voice. In this example embodiment the size of the sample set can be related to the bandwidth available in each frame.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein.

What is claimed:

1. A method for transmitting signals, the method comprising:
deriving a clock signal, wherein the clock signal is configured to be reset in response to a wireless frame synchronization signal received from a remote device;
transmitting the clock signal to a phase lock loop, wherein the phase lock loop is configured to derive a second clock signal from the clock signal for an analog to digital converter, wherein the second clock signal is set to an internal frequency used by the analog to digital converter to digitize analog signals, further wherein the second clock signal is configured to be reset in response to the wireless frame synchronization signal received from the remote device; and
transmitting, by a radio, digitized signals to the remote device, wherein the radio is configured to transmit the digital signals in wireless frames and the wireless frame transmission frequency is configured to be reset by the wireless frame synchronization signal.

2. The method of claim 1, wherein the second clock signal is up-converted to a clock rate used to digitize audio signals.

3. The method of claim 1, wherein the second clock signal is up-converted to a clock rate used to digitize video signals.

4. The method of claim 1, wherein further comprising:
deriving, by a second phase lock loop, a third clock signal for a digital to analog converter, wherein the third clock is set to an internal frequency used by the digital to analog converter to generate analog signals.

5. The method of claim 1, wherein internal clock signals are derived from a single crystal oscillator.

6. The method of claim 1, further comprising:
compressing the digitized signals.

7. A system configured to transmitting signals, the system comprising:
a radio configured to receive a frame synchronization signal from a remote device;
a timer including an input pin, a reset pin, and an output pin, wherein the input pin is configured to receive a clock signal, the output pin is configured to transmit an output clock to an analog to digital converter, and the reset pin is configured to receive the frame synchronization signal from the radio, further wherein the timer is configured to reset the output clock signal in response to receiving the frame synchronization signal from the radio; and
further wherein the analog to digital converter is configured to use the clock signal received from timer to drive an internal clock of the analog to digital converter, wherein the internal clock is used to digitize analog signals.

8. The system of claim 7, further comprising:
a controller configured to direct the analog to digital converter to transmit digitized signals to a buffer; and
the controller further configured to direct the buffer to transmit the digitized signals to the radio.

9. The system of claim 7, further wherein the radio is configured to transmit a digitized signal received from the buffer in a wireless frame and the radio is further configured to transmit frames in accordance with an internal clock signal, wherein internal clock signal is configured to reset in response to receiving the frame synchronization signal.

10. The system of claim 7, wherein the timer and the clock are components of a microprocessor.

11. The system of claim 7, further wherein the digital to analog converter is coupled to a phase lock loop and the phase lock loop is coupled to the timer, wherein the phase lock loop is configured to use the clock signal received from the timer to generate an internal clock signal to drive the internal clock of the analog to digital converter.

12. The system of claim 11, wherein the phase lock loop is configured to up-convert the clock signal received from the timer to a clock rate used to digitize audio signals.

13. The system of claim 11, wherein the phase lock loop is configured to up-convert the clock signal received from the timer to a clock rate used to digitize video signals.

14. The system of claim 7, wherein the system is embedded in a wireless headset.

15. The system of claim 7, wherein the system is embedded in a wireless microphone.

16. The system of claim 7, wherein the system is embedded in a mobile device.

17. The system of claim 7, wherein the analog to digital converter is configured to digitize signals received from an accelerometer.

18. A method for synchronizing signals transmitted over a wireless network, the method comprising:
generating a clock signal for a phase lock loop coupled to an analog to digital converter, wherein the phase lock loop is configured to generate an internal clock signal for an analog to digital converter from the clock signal, further wherein the analog to digital converter is configured to sample an audio signal at the frequency of the internal clock signal thereby generating a digital signal representative of a portion of the analog signal;
receiving a wireless frame synchronization signal from a remote device over a wireless network; and
resetting the clock signal in response to receiving the frame synchronization signal.

19. The method of claim 18, further comprising:
transmitting the digital signal in a wireless frame to a mobile device.

20. The method of claim 18, further comprising:
transmitting the digital signal in a wireless frame to a computer system.
